(19) United States
(12) Patent Application Publication
(10) Pub. No.: US 2017/0358177 A1
(43) Pub. Date: Dec. 14, 2017

(54) METHOD FOR PLAYING EXTREME THREE CARD POKER

(71) Applicants: Todd Fishon, Henderson, NV (US); Ronald LaDuca, Freehold, NJ (US)

(72) Inventors: Todd Fishon, Henderson, NV (US); Ronald LaDuca, Freehold, NJ (US)

(21) Appl. No.: 15/179,587

(22) Filed: Jun. 10, 2016

(51) Int. Cl. G07F 17/32; A63F 1/06; A63F 1/00

(52) U.S. Cl. CPC G07F 17/3293; A63F 1/00; G07F 17/3244; A63F 1/067; G07F 17/3218; G07F 17/3225; G07F 17/3211; G07F 17/322; A63F 2001/005

(57) ABSTRACT

A method of playing a casino wagering game dealt with a predetermined number of cards wherein a player forms two hands out of the player's dealt cards; a first player hand played against a best dealer hand from dealer dealt cards and a second player hand eligible to win against a payout table only if the first player hand beats the dealer hand. An optional bonus wager pays out the best three-card poker hand out of the player's dealt hand against a three-card poker bonus payout table, regardless of the player's choice of cards for the two player hands used in the regular play.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

### Field of the Invention

The present invention relates to casino card games and in particular to a method for playing a casino card game comprising a step to make two hands out of a set of dealt player cards, a primary player hand of a selected number of dealt player cards and a secondary player hand of the remaining dealt player cards, the primary player hand required to win over a best dealer hand of the same selected number of dealt dealer cards in order for the secondary player hand to be eligible to win, wherein a primary hand is paid against a dealer hand and a player secondary hand is paid out according to a payout table, and an optional bonus bet may provide a third optional bonus wager based on the value of the highest possible player bonus hand of the same selected number of dealt player cards will play against a bonus payout table and is considered regardless of how the player sets the primary and secondary player hands.

### DESCRIPTION OF RELATED ART INCLUDING INFORMATION DISCLOSED UNDER 37 CFR 1.97 AND 1.98

In the past, gaming establishments have offered a variety of poker based table games to players having different levels of sophistication. The variety of poker table games both maintain and increase interest in poker table game play and provide diversified profit centers for gaming establishments. Some players have a greater preference for playing a poker based table game where players feel they are using a level of player skill to determine the outcome of the poker table game, as opposed to playing a game that doesn't offer any decisions to be made to determine the outcome.

There are several games that allow the player to set multiple hands from a set of cards such as Pai Gow Poker. Pai Gow Poker enables a player to set two hands out of seven cards, a five card hand and a two card hand, and if the player or dealer has higher poker rankings on both hands, the wager will have an outcome. If the game results in each winning one of the hands, the outcome is a tie, which happens roughly 40% of the time. To enhance the house advantage in Pai Gow Poker, the house charges a 5% commission on winning wagers.

While Pai Gow Poker has an established following of players, it is a slow-paced game. Games that require the dealer to set multiple hands from a set of cards requires significant training for the dealers as they need to follow a specific house way to arrange their hand. This is a deterrent for a casino to offer a new game, as the training process is longer and more costly than a game where the dealer can be trained quickly.

Prior art poker games suffer from numerous disadvantages. One such disadvantage is simply that many players are tired or bored with prior art games that are mindless to play and don't offer an option of how to play their hand.

Additionally, if skill is required for the player, the dealer will need to employ a strategy, which will require additional training for the casino staff. Lastly, card games that require a player to make two hands out of a subset of cards are burdened by an excessive amount of hands that are a draw.

The poker variations that are being distributed do not offer a substantial skill element to the players. The biggest decision is whether to stay in the hand or fold which are normally very obvious decisions.

U.S. Pat. No. 6,443,455, issued Sep. 30, 2002 to Webb, indicates a two-hand poker game played using one or more decks of playing cards. To play the game, each player must place a double-hand wager and may place an optional bonus wager. Six cards are dealt to each player and the dealer, and each player and the dealer forms a high three-card hand and a low three-card hand. The double-hand wager is resolved according to game rules based on a comparison of the player high and low three-card hands and the dealer high and low three-card hands, respectively. The optional bonus wager, if received from the player, is resolved according to respective hand ranks of the player high and low three-card hands. Resolution of the double bonus wager is thus determined regardless of the result against the dealer with respect to the double-hand wager. In one operating mode, in order to increase the house advantage, a Joker is incorporated into the deck of cards, which Joker may be used differently by the players and the dealer. In an alternative operating mode, at least one of the dealer hands may be qualified such that for example when the dealer low hand is below a certain rank, the low hand is regarded as a tie, and the game outcome is determined by the high hands only.

U.S. Patent Application #20100252999, published Oct. 7, 2010 by Lopez et al, is for a method of the present invention involves a poker game in which a player is dealt a plurality of cards from which he makes a plurality, N, of starting hands. Each starting hand has a wager associated with it. After the player sets his starting hands, an opposing house starting hand is created, preferably from a number of cards capable of creating a plurality of starting hands. The player's first starting hand is completed as is the opposing house hand. If the player's first completed hand beats the opposing hand, the player receives an award and the player's next completed hand is compared to the opposing hand. If the player's first completed hand loses to the opposing hand, all wagers are lost and the game is over. This process continues until all N starting hands have been completed and evaluated or until the player loses the nth starting hand resulting in all nth to N wagers being lost.

What is needed is a casino poker game wherein a player makes a wager for each of two hands that are formed by the player from a set of dealt cards, a primary hand and a secondary hand, and the necessity for the player to win their primary hand by having a better poker hand than a dealer primary hand in order to allow the second wager the opportunity to win a multiplier based on the value of the player secondary hand against a payout table, so that players can evaluate the risk and reward of their various options.

### BRIEF SUMMARY OF THE INVENTION

An object of the present invention is to provide a casino poker game wherein a player makes a wager for each of two hands that are formed by the player from a set of dealt cards, a primary hand and a secondary hand, and the necessity for the player to win the primary hand by having a better poker hand than a dealer primary hand in order to allow the second wager the opportunity to win a multiplier based on the value of the player secondary hand against a payout table, so that players can evaluate the risk and reward of their various options for the two hands.

Another object of the present invention is to provide a preferred embodiment wherein the dealer and the player each receive a five card dealt hand and each player selects a three card poker hand to play against a dealer selected three card poker hand from the five dealt cards, and only upon beating the dealer three-card poker hand is the player allowed to play a secondary two card poker hand paid out against a two card poker payout table.

An added object of the present invention is to provide an optional bonus bet wherein a third optional bonus wager is made based on the value of the highest possible player three card poker hand out of the player's five dealt cards to be paid out against a three card poker payout table and is considered regardless of how the player sets the primary and secondary hands.

In brief, one embodiment of the invention is a method of playing a five-card poker game wherein the player will make two identical wagers and form two hands; one hand associated with each wager. The first or primary hand is a three-card poker hand and the second or secondary hand is a two-card poker hand. The primary hand competes against the dealer's best three-card hand and, only if the player wins the primary hand will the player secondary two-card poker hand be paid out against a two-card poker payout table. In one embodiment, the game is played with a set of playing cards comprising at least one deck of playing cards.

Each player initiates a game by making two wagers, an “Ante” wager and an “Ante Multiplier” wager, of equal amounts. The Ante wager is a competition with the dealer for the hand with the highest three-card poker rank and the Ante Multiplier plays against a two-card poker payout table provided the player's Ante wager wins. The player will set up a three-card poker hand for the Ante wager and a two-card poker hand for the Ante Multiplier wager. The Ante Wager will pay 1 to 1 on winning hands and an option for the Ante Multiplier will pay 10 to 1 for a Royal Flush, 4 to 1 for the straight flush, 2 to 1 for a pair, 3 to 2 for a straight, 1 to 1 for a flush, and a push for any other ranking.

A lot of hands will present multiple options for the player to consider based on the probability of winning their three-card hand and the potential value of their Ante Multiplier. If a player's hand consists of an Queen of spades, 10 of hearts, 9 of diamonds, 8 of spades, and 2 of spades, the player has a choice of playing a straight (8, 9, 10) for their Ante and a flush (Queen of spades and 2 of spades) for their Ante Multiplier or a Queen high flush for their Ante and a straight (8, 9) for their Ante Multiplier. In this case, it is beneficial to play the higher ranking hand (straight) for the Ante with the chance for a smaller multiplier for the Ante Multiplier (1 to 1 for the flush compared to 3 to 2 for the straight) since the reward of the extra payout does not make up for the risk of setting a lower ranking hand for the Ante. However, if a player's hand consists of an Queen of spades, 10 of diamonds, 9 of diamonds, 8 of spades, and 2 of spades (same hand except the 10 is now a diamond enabling a straight flush for the Ante Multiplier), the player has a choice of playing a straight (8, 9, 10) for their Ante and a flush (Queen of spades and 2 of spades) for their Ante Multiplier or a Queen high flush for their Ante and a straight flush for their Ante Multiplier. In this case, it is beneficial to play the lower ranking hand (flush) for the Ante in order to maximize the value of the straight flush for the Ante Multiplier (4 to 1 odds compared to 1 to 1 odds for playing the flush for the Ante Multiplier).

In another embodiment, a third optional wager based on the value of the highest possible three card hand out of the five cards dealt will play against a pay table and is considered regardless of how the player sets their hand.

In accordance with another embodiment of this invention the gaming table layout for presenting the game of the invention are disclosed.

The purpose of the present invention is to create a better gaming experience for people that play table games in a casino. By offering a game that has a dominant skill factor, people tend to play longer and for higher stakes, as they do in Blackjack. Most of the table game derivatives of poker do not incorporate this level of skill. The present invention would be available to casinos to install and offer to their customers.

This invention can be used as a table game in a casino where it is facilitated by a real person (dealer) or can be used as an electronic device with cards randomly selected and the electronic device settling the outcome of each round.

A primary advantage of the present invention is that it provides an improvement over prior art casino card games that are derived from poker in that the present invention requires skill in order to set a player's hand. The present invention offers players decisions on how to set their hand based on a risk vs reward analysis. Since the second hand can only win if the first hand wins and the second hand is paid based on a pay table for the poker value of the second hand, the player gets to decide whether to play a stronger first hand and sacrifice the payout of the second hand or lessen the value of their first hand to have a greater payout on their second hand. There are times when both hands can be maximized based on the composition of the cards that are dealt to the player.

The present invention allows a skill based poker variation to exist without requiring additional training for the dealer since the dealer simply sets their best hand for the first hand and does not use a second hand since the player's second hand is compared to a pay table and not the dealer's hand. Since the outcome of the game revolves around comparison of the player's first hand and the dealer's best three-card poker hand, identical hands are not common as in similar games such as Pai Gow Poker.

The claimed invention differs from what currently exists. Similar games such as Pai Gow Poker require the player to set two hands but the player only makes one wager which will win if both player's hands win, lose if both player's hand loses, and tie if one hand wins and one hand loses. Other poker variations such as Three Card Poker do not allow for a decision to be made in setting the player's hand and the only decision is whether to remain in the hand or fold the hand. Asia Poker requires a player to set three hands out of seven cards and wins if the player wins at least two of the three hands, which eliminates the issue of frequent ties but does not provide the risk vs. reward scenario that this invention features or the chance for a payout larger than 1 to 1.

The present invention is an improvement on what currently exists. The closest game is Pai Gow Poker, which also requires the player to set two hands out of a subset of cards. However, Pai Gow Poker requires an extensive training for the staff to learn how to set their hands, 40% of the hands between to player and dealer are ties, and settlement includes charging a commission on winning wagers which slows up the game. This invention eliminates the dealer training, has a small chance of tie hands (under 2%), and doesn't require the dealer to charge a commission as the house advantage is built into the game.

The current offerings work well for players that do not understand how to play a more strategic game but fail to provide a game for players that enjoy using strategy when playing a game

This invention requires players to make a decision of how to play their hand. There are hands that the decision is obvious and others that can be set multiple ways based on the strength of the first hand compared to the payout of the second hand. While there is always a mathematically superior way to set a hand, the player will have to decide if they want the better chance to win the hand or a less chance to win but a bigger return if they do win.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a plan view of an extreme three card poker layout of the present invention on a casino card playing table layout for carrying out the steps of the method of the present invention, showing the player layouts and payout tables facing the players and the dealer layout and payout tables facing the dealer on the other side of the playing table from the players;

FIG. 1A is an exploded plan view of a player layout of FIG. 1;

FIG. 2 is an exploded plan view showing a player layout and payout tables of the extreme three card poker layout of FIG. 1;

FIG. 3 is an elevational view of a simulation of the extreme three card poker layout of the present invention shown on a screen of an electronic simulation device showing a simulation of the player layouts and payout tables and the dealer layout and payout tables;

FIG. 4 is an elevational view of a simulation of the extreme three card poker layout of the present invention shown on a screen of a computer device showing a simulation of the player layouts and payout tables and dealer layout and payout tables;

FIG. 5 is an elevational view of a simulation of the extreme three card poker layout shown on a screen of a wireless device showing a simulation of the player layouts and payout tables.

### DETAILED DESCRIPTION OF THE INVENTION

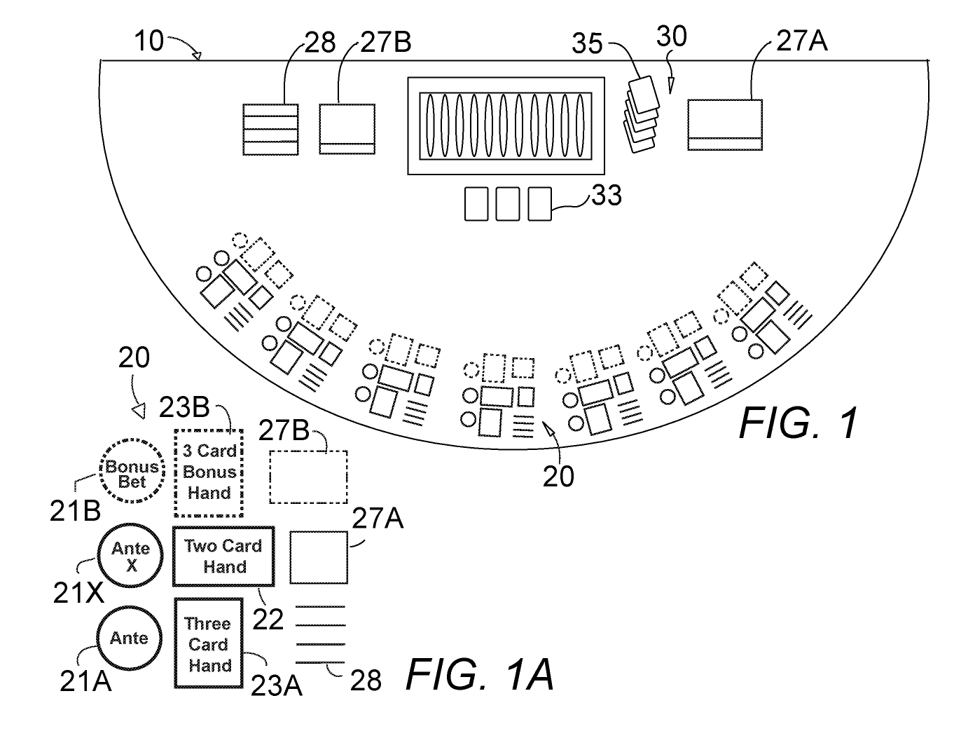

In FIGS. 1-5, a method of playing a casino wagering card game comprises placing a primary player hand wager, the ante 21A, against a dealer hand 33u and a secondary player hand wager, the ante multiplier 21X, against a payout table 27A, the secondary player hand wager paid out only upon a condition that the primary player hand wager is won against the dealer hand, otherwise both the primary player hand wager and the secondary player hand wager are both lost, the primary player hand wager betting at least one player primary hand 23A of a selected number of cards from player dealt cards 25 against a dealer hand 33 of the same selected number of cards from dealer dealt cards 35 forming a best dealer hand, and the secondary player wager betting at least one player secondary hand 22 of the remaining player dealt cards against a payout table 27A only if the player primary hand 23A beats the dealer hand 33.

The method further comprises a step of making an optional player bonus wager 21B on a value of a player best hand 23B formed from the same selected number of cards from the player dealt cards 25 and paying out the player bonus wager according to payout odds on a bonus wager payout table 27B.

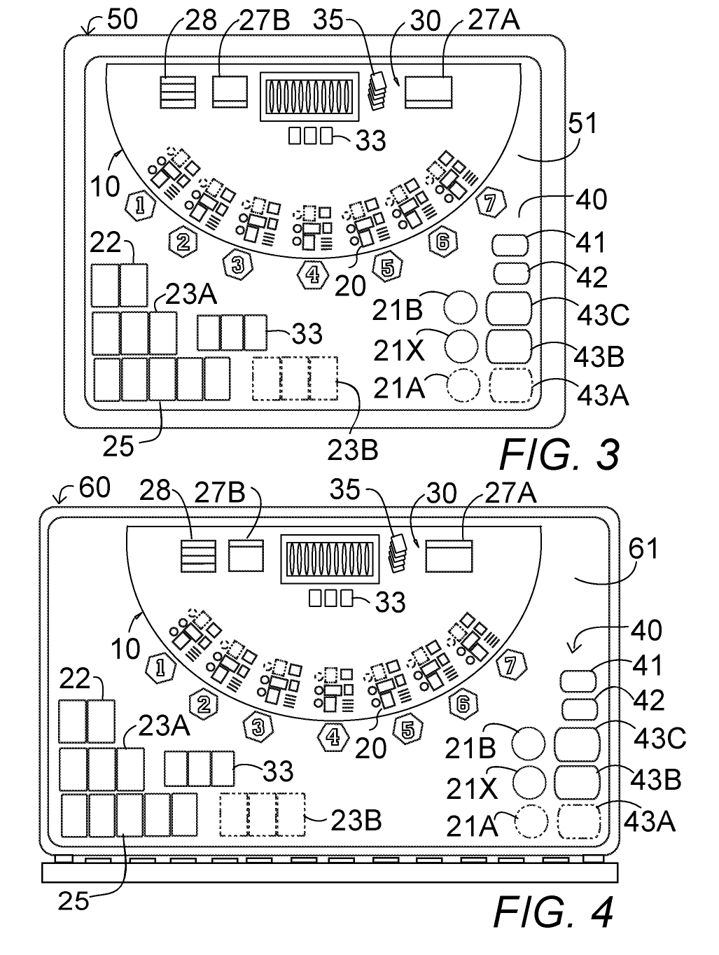

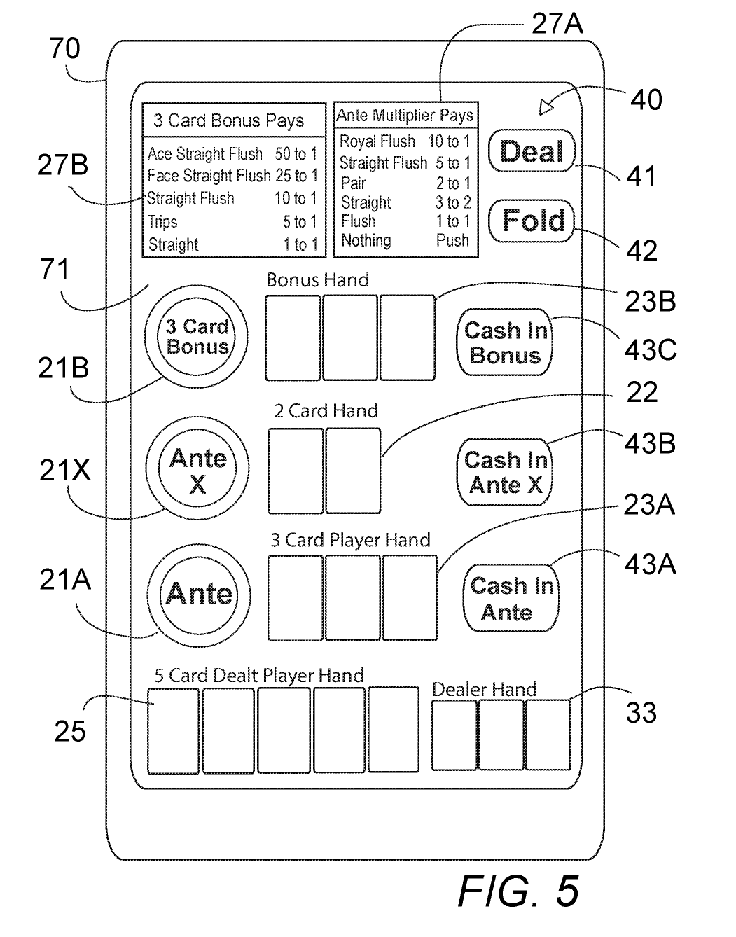

The method of carrying out the steps of the method of playing a casino wagering card game of the present invention is carried out using a casino wagering card game layout 10 on a casino wagering card game device taken from the list of casino wagering card game devices consisting of an actual casino card gaming table 10 of FIG. 1, a simulated casino card gaming device, a simulated mechanical casino card gaming device similar to the actual casino card gaming table 10, a simulated electronic casino card gaming device of FIGS. 3-5, a simulated electronic casino card gaming device having a connection to a remote network, a computer device 60 of FIG. 4, a handheld device 70 of FIG. 5, a telephonic device, an entertainment device, a gaming device with a video screen 51 of FIG. 3, a video terminal on a screen 51 of FIG. 3, and a television device with a similar screen 51.

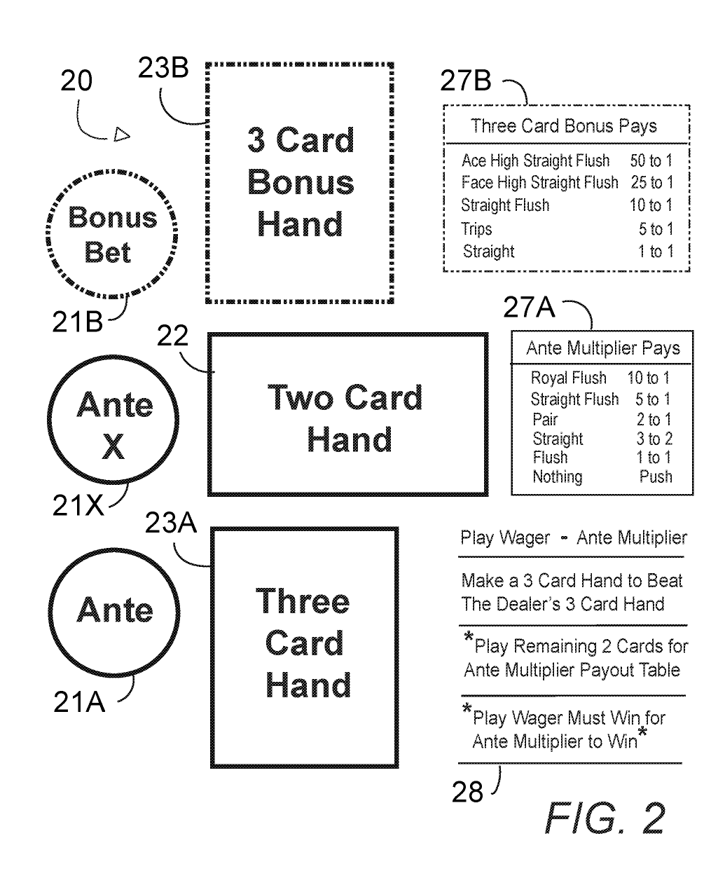

In more detail as shown in FIGS. 1, 1A and 2, the method of the present invention comprises playing an extreme three card poker casino card game wagering at least one player primary hand 23A of three selected player dealt cards forming a three card poker hand against a dealer hand 33 of three selected dealer dealt cards forming a dealer best three card poker hand and paying out at least one player secondary hand 21X forming a two card poker hand against a payout table 27A only if the player primary hand 23A wins against the dealer hand 33, the method comprising the following steps:

(a) providing an extreme three card poker layout 10 having at least one player location 20 and one dealer location 30 for carrying out the method of playing an extreme three card poker casino card game and at least one standard 52-card poker deck;

(b) placing at least one player ante wager 21A and at least one player ante multiplier wager 21X at designated wager locations in the at least one player location 20 on the extreme three card poker layout 10;

(c) dealing one set of five player cards 25 at each player location 20 making the wagers and one set of five dealer cards 35 at the dealer location 30 on the extreme three card poker layout 10 from the standard 52-card poker deck;

(d) forming a player primary hand 23A of three cards selected from each of the at least one set of five dealt player cards 25 based on a poker ranking for a three-card poker hand representing the player ante wager 21A; forming a player secondary hand 22 of two cards from each of the remaining at least one set of dealt player cards based on a poker ranking for a two card poker hand representing the player ante multiplier wager 21X, and placing each of the player primary and secondary hands in designated player hand locations at each of the player locations 20;

(e) forming a dealer hand 33 of a best three-card poker hand from the set of five dealt dealer cards 35 and placing the dealer hand in a designated dealer hand location 33 at the dealer location 30, and discarding the remaining two cards from the set of dealt dealer cards;

(f) comparing each of the player primary hands to the dealer hand;

(g) if the dealer hand comprises a higher poker ranking than the player primary hand, taking the player ante wager and the player ante multiplier wager; if the dealer hand and the player primary hand have the same poker ranking, pushing both the player ante wager and the player ante multiplier wager; if the player primary hand has a higher poker ranking than the dealer hand, paying the player ante wager 1 to 1, and paying out the player secondary hand against a predetermined two card poker payout table 27A on the extreme three card poker layout 10.

The method of the present invention wherein the fourth step (d) of forming a player primary hand of three cards selected from each of the at least one set of five dealt player cards and the fifth step (e) of forming a dealer hand of a best three-card poker hand from the set of five dealt dealer cards are each based on poker rankings for each of the three card hands of a Royal Flush, a Straight Flush, Three of a kind, a Straight, a Flush, a Pair, and High Card.

The method of the present invention wherein the seventh step (g) of paying out the player secondary hand of two cards comprises paying out the player two card poker secondary hand according to a two card poker payout table 27A paying odds of at least 10 to 1 for a Royal Flush, 4 to 1 for a Straight Flush, 2 to 1 for a Pair, 3 to 2 for a Straight, 1 to 1 for a Flush, and a push for any hand less than a Flush.

The method of the present invention wherein the second step (b) further comprises making an optional player bonus wager 21B on a poker value of a player best three card poker hand 23B formed from the same set of five dealt player cards and paying out the player bonus wager according to payout odds on a three card poker bonus wager payout table 27B.

The step of paying out the optional player bonus wager 21B for any best player three card poker hand 23B having a poker value of a straight or higher according to the payout odds of the three card poker bonus wager payout table 27B, preferably comprises paying out according to odds of at least 40 to 1 for an Ace High Straight Flush, 25 to 1 for a Face High Straight Flush, 5 to 1 for Three of a Kind, and 1 to 1 for a Straight.

In FIG. 1, the method of the present invention comprises carrying out the steps of the method of the present invention by dealing from a physical deck of cards on an extreme three card poker layout 10 on a casino card gaining table, placing wagers 21A, 21X, and 21B and placing the player primary hand 23A, secondary hand 22, and bonus hand 23B at a plurality of so demarked player layouts 20 on the casino card gaming table layout 10 and placing the dealer hand 33 on a so demarked dealer layout on the casino card gaming table layout 10.

In FIGS. 1-5, the method of the present invention may comprise carrying out the steps of the method of the present invention using a casino card gaming table simulation device simulating the casino card table extreme three card poker layout of FIG. 1, having a plurality of player layouts 20 and a dealer layout 30 of the extreme three card poker layout on the simulation device, the steps comprising placing wagers in specified wager locations 21A, 21X, and 21B on each of the player layouts 20 of the simulation device and placing the selected player hands 23A, 22, and 23B in specified player hand locations on each of the player layouts 20 of the simulation device and placing the selected dealer hand 33 on a specified dealer hand location on the dealer layout 30 of the simulation device, and making payouts according to designated 1 to 1 payouts for the primary player hand wager 21A against the dealer hand and designated payouts tables 27A for each player secondary hand 22 and designated bonus wager payout tables 27B for each player bonus hand 23B for players making the optional bonus bet, as indicated on the simulation device.

The method of carrying out the steps of the method of the present invention may comprise dealing from a physical deck of cards on a mechanical simulation device having a plurality of player layouts 20 and a dealer layout 30 on the mechanical simulation device physically simulating an extreme three card poker layout on a casino card gaming table, such as a packaged extreme three card poker layout simulating the casino card table layout of FIGS. 1, 1A, and 2.

The method may comprise carrying out the steps of the present invention on an electronic simulation device 50, 60, and 70, as shown in FIGS. 3-5, the electronic simulation device comprising a screen 51, 61, and 71 showing a virtual extreme three card poker layout 10 electronically simulating the casino card gaming table of FIGS. 1, 1A and 2, including a virtual representation of a plurality of player layouts 20 and a dealer layout 30 on the screen of the electronic simulation device. The method of carrying out the steps of the present invention comprises selecting screen location input means 40, which may be a mouse or keyboard or touchscreen or other means for inputting into electronic devices into the electronic simulation device selecting various options on the screen in the screen location input means 40 to choose selected steps of activity including deal 41, fold 42, cash in ante 43A, cash in Ante Multiplier 42B, and optionally cash in bonus 43C to carry out a step of placing virtual wagers in specified wager locations 21A, 21X and 21B on each of the virtual player layouts 20 of the electronic simulation device, a step of dealing out player and dealer sets of five virtual dealt cards each 25, and a step of placing the selected player virtual hands 23A, 22, and 23B in specified player hand locations on each of the virtual player layouts 20 of the electronic simulation device, and a step of placing the selected dealer virtual best three card poker hand 33 on a specified dealer hand location on the dealer layout 30 of the electronic simulation device, and making virtual payouts according to designated 1 to 1 payouts for the primary player hand wager 21A against the dealer hand and designated payouts tables 27A for each player secondary hand 22 and designated bonus wager payout tables 27B for each player bonus hand 23B for players making the optional bonus bet, as indicated on the electronic simulation device.

In FIG. 5, the method comprises carrying out the steps of the method of the present invention on a handheld electronic simulation device 70 comprising a touch screen 71 for interacting with the handheld electronic simulation device 70. The handheld electronic simulation device 70 comprises a touch screen 71 showing a virtual extreme three card poker layout electronically simulating a casino card gaming table including a virtual representation of at least one player layout 20 and at least a dealer hand 33 on the touch screen of the electronic simulation device. The steps comprise touching the screen 71 to play the game using the method of the present invention to make inputs to the handheld electronic simulation device 70 to carry out a step of placing virtual wagers 21A, 21X, and 21B in specified wager locations on the at least one virtual player layout 20 of the handheld electronic simulation device, a step of simulating dealing out player dealt cards 25, and a step of simulating placing the selected player virtual hands 23A, 22, and optional player bonus hand 23B in specified player hand locations on the at least one virtual player layout 20 of the handheld electronic simulation device 70, and a step of placing the selected dealer best three card poker virtual hand 33 on a specified dealer hand location on the dealer layout of the handheld electronic simulation device, and making virtual payouts according to designated 1 to 1 payouts for the primary player hand wager 21A against the dealer hand and designated payouts tables 27A for each player secondary hand 22 and designated bonus wager payout tables 27B for each player bonus hand 23B for players making the optional bonus bet, as indicated on the electronic simulation device.

Inputs are made on the handheld electronic simulation device by touching the touch screen 71 to place wagers 21A, 21X, and optionally 21B, to select cards for the player hands 23A, 22 and optionally 23B, and in the direction input location 40 to choose selected steps of activity including deal 41, fold 42, cash in ante 43A, cash in Ante Multiplier 42B, and optionally cash in bonus 43C. The same inputs are made in the other electronic simulation devices of FIGS. 3 and 4 by selecting screen location input means 40, which may be carried out using a mouse or keyboard or touchscreen or other means for inputting into electronic devices into the electronic simulation device.

The steps of the method of the present invention may be carried out on an electronic simulation device, which may be a communication electronic simulation device, having a connection to a remote network, such as an on an internet connection, which may be a wired or wireless device, wherein a player uses the electronic simulation device having a connection to a remote network to play the game remotely using the method of the present invention.

The steps of the method of the present invention may be carried out on an electronic simulation device, and the electronic simulation device comprises a device taken from the list of electronic simulation devices comprising a computer, a handheld device, a telephonic device, an entertainment device, a gaming device, a video terminal, and a television device.

In use in a casino card game version of the present invention of FIGS. 1, 1A and 2, each player who wishes to play the game places a first bet or wager (“Ante”) and second bet or wager (“Ante Multiplier”). Each Ante is preferably received in the corresponding primary hand wager Ante location 21A of the layout and each Ante Multiplier is preferably received in the corresponding secondary hand Ante Multiplier location 21X of the player layout 20. Each player who places an Ante and Ante Multiplier wager may also place an optional third bet or wager (“Three Card Bonus” wager). Each Three Card Bonus wager is preferably received in the corresponding Three Card Bonus wager location 21B of the player layout 20. The Three Card Bonus wager is a wager that the player's hand will achieve at least a first predetermined rank.

After each player who desires to play the game has placed a mandatory Ante wager and Ante Multiplier wager and an optional Three Card Bonus wager, the dealer deals a set of five player dealt cards 25 from the deck of playing cards to each player. The dealer also deals a set of five dealer dealt cards 35. Players may then inspect their dealt cards.

In regular play, the players separate their five-card hand into two hands, a primary hand 23A consisting of three cards used to play three card poker against a dealer three-card hand 33 for the Ante wager 21A and a secondary hand 22 consisting of two cards played against a two-card payout table 27A for the Ante Multiplier wager 21X, if and only if the three card poker player primary hand 23A beats the best three card poker dealer hand 33. If the three-card poker player primary hand 23A does not beat the three-card poker dealer hand 33, the player loses both the Ante wager 21A and the Ante Multiplier wager 21X. If the three-card poker player primary hand 23A beats the three-card poker dealer hand the remaining two card poker player secondary hand 22 will be compared against a predetermined two card poker payout table 27A for payout of the Ante Multiplier bet 21X.

After all players have an opportunity to set their two hands, the dealer will reveal the dealer's five dealt cards and examine the five dealer cards to determine the best three-card hand available out of the five cards. The dealer will not use the remaining two cards.

The dealer will compare each of the three card poker player primary hands 23A with the three card poker dealer hand 33 and determine which hand has the higher poker value. If the three card poker dealer hand 33 has the higher poker value, the player's Ante wager 21A and Ante Multiplier wager 21X will lose. If the dealer hand 33 and the player primary hand 23A have the same three card poker value, the hands are a push (tie). If the three card poker player hand 23A has a higher poker value than the dealer hand 33, the player Ante wager 21A will win 1 to 1 and the player Ante Multiplier wager 21X will win based on the poker ranking of the two card poker player secondary hand 22 compared to a predetermined two-card poker payout table 27A with the following odds:

Two Card Royal Flush: Ace and King in the same suit—10 to 1

Straight Flush: Two cards in sequence and same suit—5 to 1

Pair: Two cards of the same rank—2 to 1

Straight: Two cards in sequence—3 to 2

Flush: Two cards in the same suit—1 to 1

High Card: Two cards that do not meet the criteria listed above—push (tie)

In another embodiment of the invention, each active player who placed a Three Card Bonus wager 21B is paid winnings if their best three card poker player bonus hand 23B meets a predetermined minimum rank. In one embodiment, the players are paid winnings for their Three Card Poker player bonus wager 21B in accordance with a bonus three card poker pay table 27B. One exemplary Three Card Bonus wager pay table is as follows:

Ace High Straight Flush: Ace, King, & Queen all in the same suit—at least 40 to 1

Face High Straight Flush: King, Queen, Jack or Queen, Jack, Ten, or Jack, Ten, Nine all in the same suit—at least 25 to 1

Straight Flush: Three cards in sequence and of the same suit—at least 10 to 1

Three of a Kind: Three cards of the same rank—at least 2 to 1

Straight: Three cards in sequence—at least 3 to 2

If the player's hand is other than a winning hand (for example, pair of 4's), the player loses their Three Card player bonus wager 21B (the dealer collects the wager).

It is understood that the preceding description is given merely by way of illustration and not in limitation of the invention and that various modifications may be made thereto without departing from the spirit of the invention as claimed.

What is claimed is:

1. A method of playing a casino wagering card game comprises placing a primary player hand wager against a dealer hand and a secondary player hand wager against a payout table, the secondary player hand wager paid out only upon a condition that the primary player hand wager is won against the dealer hand, otherwise both the primary player hand wager and the secondary player hand wager are both lost, the primary player hand wager betting at least one player primary hand of a selected number of cards from player dealt cards against a dealer hand of the same selected number of cards from dealer dealt cards forming a best dealer hand, and the secondary player wager betting at least one player secondary hand of the remaining player dealt cards against a payout table only if the player primary hand beats the dealer hand.

2. The method of claim 1 further comprising a step of making an optional player bonus wager on a value of a player best hand formed from the same selected number of cards from the player dealt cards and paying out the player bonus wager according to payout odds on a bonus wager payout table.

3. The method of claim 2 comprising carrying out the steps of the method of playing a casino wagering card game of the present invention on a casino wagering card game layout on a casino wagering card game device taken from the list of casino wagering card game devices consisting of an actual casino card gaming table, a simulated casino card gaming device, a simulated mechanical casino card gaming device, a simulated electronic casino card gaming device, a simulated electronic casino card gaming device having a connection to a remote network, a computer device, a handheld device, a telephonic device, an entertainment device, a gaming device, a video terminal, and a television device.

4. A method of playing an extreme three card poker casino card game wagering at least one player primary hand of three selected player dealt cards forming a three card poker hand against a dealer hand of three selected dealer dealt cards forming a dealer best three card poker hand and paying out at least one player secondary hand forming a two card poker hand against a payout table only if the player primary hand wins against the dealer hand, the method comprising the following steps:
(a) providing an extreme three card poker layout having at least one player location and one dealer location for carrying out the method of playing an extreme three card poker casino card game and at least one standard 52-card poker deck;
(b) placing at least one player ante wager and at least one player ante multiplier wager at designated wager locations in the at least one player location on the extreme three card poker layout;
(c) dealing one set of five player cards at each player location making the wagers and one set of five dealer cards at the dealer location on the extreme three card poker layout from the standard 52-card poker deck;
(d) forming a player primary hand of three cards selected from each of the at least one set of five dealt player cards based on a poker ranking for a three-card poker hand representing the player ante wager; forming a player secondary hand of two cards from each of the remaining at least one set of dealt player cards based on a poker ranking for a two card poker hand representing the player ante multiplier wager, and placing each of the player primary and secondary hands in designated player hand locations at each of the player locations;
(e) forming a dealer hand of a best three-card poker hand from the set of five dealt dealer cards and placing the dealer hand in a designated dealer hand location at the dealer location, and discarding the remaining two cards from the set of dealt dealer cards;
(f) comparing each of the player primary hands to the dealer hand;
(g) if the dealer hand comprises a higher poker ranking than the player primary hand, taking the player ante wager and the player ante multiplier wager; if the dealer hand and the player primary hand have the same poker ranking, pushing both the player ante wager and the player ante multiplier wager; if the player primary hand has a higher poker ranking than the dealer hand, paying the player ante wager 1 to 1, and paying out the player secondary hand against a predetermined two card poker payout table on the extreme three card poker layout;
thereby playing out a method of playing an extreme three card poker casino card game wagering at least one player primary hand of three selected player dealt cards forming a three card poker hand against a dealer hand of three selected dealer dealt cards forming a dealer best three card poker hand and paying out at least one player secondary hand forming a two card poker hand against a payout table only if the player primary hand wins against the dealer hand.

5. The method of claim 4 wherein the fourth step (d) of forming a player primary hand of three cards selected from each of the at least one set of five dealt player cards and the fifth step (e) of forming a dealer hand of a best three-card poker hand from the set of five dealt dealer cards are each based on poker rankings for each of the three card hands of a Royal Flush, a Straight Flush, Three of a kind, a Straight, a Flush, a Pair, and High Card.

6. The method of claim 4 wherein the seventh step (g) of paying out the player secondary hand of two cards comprises paying out the player two card poker secondary hand according to a two card poker payout table paying odds of at least 10 to 1 for a Royal Flush, 4 to 1 for a Straight Flush, 2 to 1 for a Pair, 3 to 2 for a Straight, 1 to 1 for a Flush, and a push for any hand less than a Flush.

7. The method of claim 4 wherein the second step (b) further comprises making an optional player bonus wager on a poker value of a player best three card poker hand formed from the same set of five dealt player cards and paying out the player bonus wager according to payout odds on a three card poker bonus wager payout table.

8. The method of claim 7 wherein the step of paying out the optional player bonus wager for any best player three card poker hand having a poker value of a straight or higher according to the payout odds of the three card poker bonus wager payout table, comprises paying out according to odds of at least 40 to 1 for an Ace High Straight Flush, 25 to 1 for a Face High Straight Flush, 5 to 1 for Three of a Kind, and 1 to 1 for a Straight.

9. The method of claim 7 comprising carrying out the steps of the method of the present invention by dealing from a physical deck of cards on an extreme three card poker layout on a casino card gaming table, placing wagers and placing the player primary, secondary, and bonus hands at a plurality of player layouts on the casino card gaming table and placing the dealer hand on a dealer layout on the casino card gaming table.

10. The method of claim 7 comprising carrying out the steps of the method of the present invention using a casino card gaming table simulation device having a plurality of player layouts and a dealer layout of the extreme three card poker layout on the simulation device, the steps comprising placing wagers in specified wager locations on each of the player layouts of the simulation device and placing the selected player hands in specified player hand locations on each of the player layouts of the simulation device and placing the selected dealer hand on a specified dealer hand location on the dealer layout of the simulation device, and making payouts according to designated payouts tables indicated on the simulation device.

11. The method of claim 10 comprising carrying out the steps of the method of the present invention by dealing from a physical deck of cards on a mechanical simulation device having a plurality of player layouts and a dealer layout on the mechanical simulation device physically simulating an extreme three card poker layout on a casino card gaming table, the steps further comprising placing wagers in specified wager locations on each of the player layouts of the mechanical simulation device and placing the selected player hands in specified player hand locations on each of the player layouts of the mechanical simulation device and placing the selected dealer hand on a specified dealer hand location on the dealer layout of the simulation device, and making payouts according to designated payouts tables indicated on the mechanical simulation device.

12. The method of claim 10 comprising carrying out the steps of the method of the present invention on an electronic simulation device, the electronic simulation device comprising a screen showing a virtual extreme three card poker layout electronically simulating a casino card gaming table including a virtual representation of a plurality of player layouts and a dealer layout on the screen of the electronic simulation device, the steps further comprising using input means into the electronic simulation device to carry out a step of placing virtual wagers in specified wager locations on each of the virtual player layouts of the electronic simulation device, a step of dealing out player and dealer sets of five virtual dealt cards each, and a step of placing the selected player virtual hands in specified player hand locations on each of the virtual player layouts of the electronic simulation device, and a step of placing the selected dealer virtual best three card poker hand on a specified dealer hand location on the dealer layout of the electronic simulation device, and making virtual payouts according to designated payouts tables indicated on the electronic simulation device.

13. The method of claim 12 comprising carrying out the steps of the method of the present invention on a handheld electronic simulation device comprising a touch screen means for interacting with the handheld electronic simulation device, the handheld electronic simulation device comprising a touch screen showing a virtual extreme three card poker layout electronically simulating a casino card gaming table including a virtual representation of at least one player layout and a dealer layout on the touch screen of the electronic simulation device, the steps comprising touching the screen to play the game using the method of the present invention to make inputs to the handheld electronic simulation device to carry out a step of placing virtual wagers in specified wager locations on the at least one virtual player layout of the handheld electronic simulation device, a step of simulating dealing out player and dealer sets of five virtual cards each, and a step of simulating placing the selected player virtual hands in specified player hand locations on the at least one virtual player layout of the handheld electronic simulation device, and a step of placing the selected dealer best three card poker virtual hand on a specified dealer hand location on the dealer layout of the handheld electronic simulation device, and making virtual payouts according to designated payouts tables indicated on the handheld electronic simulation device.

14. The method of claim 12 comprising carrying out the steps of the method of the present invention on an electronic simulation device having a connection to a remote network, wherein a player uses the electronic simulation device having a connection to a remote network to play the game remotely using the method of the present invention.

15. The method of claim 14 comprising carrying out the steps of the method of the present invention on an electronic simulation device having a wired connection to a remote network, wherein a player uses the electronic simulation device having a connection to a remote network to play the game remotely using the method of the present invention.

16. The method of claim 14 comprising carrying out the steps of the method of the present invention on an electronic simulation device having a wireless connection to a remote network, wherein a player uses the electronic simulation device having a connection to a remote network to play the game remotely using the method of the present invention.

17. The method of claim 14 comprising carrying out the steps of the method of the present invention on a communication electronic simulation device having a connection to a remote network, wherein a player uses the communication electronic simulation device having a connection to a remote network to play the game remotely using the method of the present invention.

18. The method of claim 14 comprising carrying out the steps of the method of the present invention on an electronic simulation device having a connection to a remote network, wherein a player uses the electronic simulation device having a connection to a remote network to play the game remotely using the method of the present invention, and the electronic simulation device comprises a device taken from the list of electronic simulation devices comprising a computer, a handheld device, a telephonic device, an entertainment device, a gaming device, a video terminal, and a television device.
